(19) United States
(12) Patent Application Publication
(10) Pub. No.: US 2005/0020163 A1
(43) Pub. Date: Jan. 27, 2005

(54) Structural composite having decorated outer surface and method of making the same

(76) Inventor: Sam Saeed Shariat, Rolling Hills Estates, CA (US)

Correspondence Address: Terrell P. Lewis;Unit #8, 343 Palos Verdes Boulevard, Redondo Beach, CA, 90277, US

(21) Appl. No.: 10/624,722

(22) Filed: Jul. 21, 2003

(51) Int. Cl. B32B 17/04

(52) U.S. Cl. 442/180; 427/340; 427/385.5; 427/407.1; 442/178; 442/179; 442/251; 442/254

(57) ABSTRACT

Disclosed is a decorated structural composite element that includes, in its simplest form, a layer of composite material, a barrier layer disposed over the composite material layer, and a decoration atop the barrier layer. The barrier layer comprises an optically light pigment material, which is interposed between the decoration and the optically dark composite material. The optically light pigment material can be supported by a the barrier layer, but it may also be carried by a layer which supports the decoration. The barrier layer may comprise a coating. Preferably, the layer that bears the decoration comprises a layer of woven or non-woven material, which most preferably is a polyester material. Resin is applied to the composite material and is cured to form a structural element. The composite structural element may be shaped before curing.

### BACKGROUND OF THE INVENTION

1. Field of the Invention

The present invention relates to structural composites, and more particularly to structural composites which bear indicia or designs, and even more particularly, to an article of composite material and a method of making the same in which the article exhibits one or more surface regions bearing indicia or design information which has been applied to the surface region(s) through a sublimation printing process.

The present invention further concerns a method of manufacturing an article fabricated from carbon-based composite materials having on one or more outer surfaces thereof a decorative pattern. Preferably, the decorated surface includes a decorative image or pattern of images, or indicia such as alpha-numeric characters. The decorated surface preferably comprises a layer of material to which the decorative image or indicia has been applied before the layer has been incorporated into the article. The decorative layer is preferably secured to the composite article surface(s) by the application and curing of resin material. More particularly, the present invention is a method of making a composite structure bearing decorative images on an outer surface, and the article formed by practicing the method.

2. Description of the Related Art

The fabrication of structural elements, and assemblies made from such elements, using composite materials to obtain increased strength-to-weight characteristics and other improved properties is well known. Such elements typically are comprised of high strength fibers embedded in a polymer matrix. In a similar manner, assemblies of composite materials are made from layers of such elements embedded in a polymer resin matrix. Such composite materials have excellent strength to weight characteristics and wide application, including construction or building products, sporting equipment, furniture and other furnishings, etc. The typical process for forming a composite structure entails building a stack of layers or plies of composite material and embedding the entire stack in the polymer resin matrix. In this situation, each ply can be the same or different material and the fibers in each ply can be wrapped with different braiding patterns to satisfy pre-specified requirements of a particular structure.

The processes employed and the apparatus used for practicing these processes are known to those skilled in the art. They include a pultrusion process and a resin transfer molding process. Fiber materials which have been employed in the composite industry include aramid, glass, carbon, or graphite, as well as materials such as ceramics and boron. The polymer matrix material typically is a thermoset resin such as polyester or epoxy resin. Alternatively, a variety of thermoplastic resins such as nylons polypropylene, polycarbonate and the like have been used.

Sublimation-printing is a technique to imprint indicia in the form of designs, logos, characters, etc. into an article. The term “into”, as used herein, means that the sublimation dye penetrates and/or becomes part of the outer surface of the article. Generally, sublimation is a direct transformation from a solid state to a vapour state, and sublimable inks are transferred by heat and pressure from sheets or rolls to the articles to be printed or decorated when the sheets or rolls are pressed against the articles and then heated. Sublimation printing or decoration has many advantages compared to other decoration processes. In fact, in sublimation printing, vapors of the ink penetrate the article being printed and generate vivid and very pleasant, decorations of virtually no thickness.

Many manufactured articles made of composite materials, especially carbon-based composite materials, require labeling on an external surface for environmental, aesthetic, identification or safety purposes. Quite frequently, the surface of the article does not lend itself to imprinting with indicia that are visually distinct and highly perceptible. This is because the composite structure typically has an optically dark, nearly black, surface due to the inherently dark coloration of the constituent resins and fibers. Thus, a surface, or surface coating, of an optically light color is required before application of the decoration or indicia to the external surface. Without such optically light surface or surface coating, the applied image(s) will be so visually indistinct from the surface(s) of the composite article that it would be difficult, if not nearly impossible, to discern the image.

The best results for sublimation printing are achieved with most polyester materials because these materials most readily accept penetration of sublimable inks, but it is well known that nearly all materials may be sublimation-printed if a an adherent layer is previously applied to or on the same. Sublimation printing of substantially flat articles is easily achievable and is generally carried out with hot presses or irons, which press sublimable ink-bearing sheets into intimate contact with the articles to be decorated. Typically, the temperature desired to effect sublimation printing is between about 180 degrees C. and 215 degrees C., depending on the inks and colors utilized, and the pressure must be sufficient to ensure a direct touch between the plates and the articles.

One approach to this problems encountered in practicing prior known methods was suggested by U.S. Pat. No. 6,004,900 to O'Brien, III, in which the inventor discloses an article made of “unconventional” composite materials and a method of manufacture of the article, in which the article carries an image applied through a sublimation printing process. The patentee describes, as the state of the art, the manufacture of composite articles having an outermost surface that provides an optically light color for application of visually distinct sublimation print, where the process consists of the steps of forming the article from “conventional” composite materials, coating the surface of the article with an “unconventional” optically light surface ready for application of visually-distinct sublimation print, and sublimation printing on the optically light surface. In contrast, the composite article of the patent is manufactured by incorporating into the resin mixture an optically-light coloration additive, such as titanium dioxide, which, following curing of the article, renders the surfaces of the article ready for application of visually distinct sublimation print.

Another approach, disclosed in U.S. Pat. No. 5,811,371 to Egashira et al. involves the manufacture of an article made of materials other than composite materials that includes a first “image receiving sheet” comprising a base sheet and a second receiving layer for receiving a dye or pigment applied through a sublimation printing process, where the receiving layer makes contact with the sublimation printing apparatus and contains a white pigment, specifically a pigment such as titanium dioxide.

Composite materials are very versatile and exhibit exceptional mechanical characteristics. While they were originally developed by the defense and aerospace industry for high technology applications, in recent years these materials are becoming utilized in a wide range of applications such as for use as arrow shafts, golf club shafts, fishing rods, baseball bats, airframe structures, tool handles, boat hulls, etc.

For example, U.S. Pat. No. 6,520,876 to Eastman, II discloses a method for forming a reinforced archery arrow shaft, which involves helically wrapping a decorated layer about the arrow shaft, while U.S. Pat. No. 5,090,149 to Muk Kim teaches placing a decorated external fabric sleeve about a the shaft of a fishing rod, and then covering the fabric sleeve with a transparent coating.

None of the solutions proposed heretofore teach or even suggest how to obtain a visible image on, and applied directly to, an optically dark substrate, and in particular to an optically dark, carbon-containing composite substrate, which, after the resin is applied and the whole structure cured, permits the image to remain optically visible.

A need therefore exists for decorated composite articles, and a method for making such articles, and in particular, decorated carbon-based composite articles, which carry a visually identifiable image or pattern thereon, in which the pattern or image is visually observable even, and especially, after application of resin to the layers of the composite article and curing of the resin impregnated structural article.

In contrast to the foregoing teachings, the applicant has solved this problem using a different, non-obvious, process, and as a result has obtained a different, heretofore unobvious product.

### OBJECTS AND SUMMARY OF THE PRESENT INVENTION

It is therefore an object of the present invention to provide a method for applying a decorative image to a structural element while overcoming the problems and disadvantages of previously known processes for doing the same.

Another object of the present invention is to provide a method and article formed by practice of the method, for providing a decorated structural element typically formed of multiple layers of optically dark, carbon-based, composite materials, in which an optically light “barrier” layer of an optically light material is applied behind a layer on which an image is to be formed using a sublimation printing process. The present invention also embraces the inclusion of layers of material which are not fabric or of composite material; for example, it is known that structural elements can be made which include layers of non-composite materials, such as metal or wood or stone, sandwiched between layers of the composite materials.

In principal, the process of the present invention contemplates placing a barrier layer between the image-bearing layer and the optically dark composite structure onto which the image bearing layer is applied. The barrier layer preferably comprises a woven or non-woven sheet of material, either of polyurethane or bearing a coating of polyurethane, or a film, which sheet or film has been coated on one side with an optically light pigment. The most effective optically light pigment so far used by applicant is white in color. The barrier layer thus formed inhibits absorption of the resin material and thus maintains its optically light properties even before the curing process begins. This is in contrast with conventional methods as taught or suggested by the references described above, where when the resin is applied to and over the stack of structural layers, the optically light properties of image-bearing layers has a tendency to diminish so substantially that the image effectively can no longer be discerned.

The present invention provides an improved method for securing an image-bearing sheet of material to and atop a stack of composite, or composite and disparate, materials in such a manner that, following curing, the image can still be seen. Preferably, the composite materials are optically dark, and the image on the image-bearing sheet of material is placed thereon through a sublimation printing process.

The image-bearing layer may be comprised of a piece of woven or non-woven fabric material, which is disposed atop and affixed to the stack of composite material.

In a preferred embodiment of the invention, the image-bearing layer is formed from a decorated fabric, which has been provided with a design or other image on the exterior surface thereof.

In the method of the present invention, a resin applied to the whole stack of composite material layers is cured to adhere the layers together. The resin may be impregnated into the fabric prior to its placement in the buildup of the core structure, or alternatively, may be applied to the fabric by conventional methods such as spraying, dipping, brushing, or powder coating, after the fabric is applied to the core structure.

The resin may be applied as a liquid and air-dried, or alternatively, may be a thermosetting resin, which is cured by heating.

In one embodiment of the invention, the structural element may also be formed as a fiber-reinforced composite structure which is resistant to cracking, warping, splitting and/or breakage thereof.

### BRIEF DESCRIPTION OF THE DRAWINGS

For a more complete understanding of the present invention, the reader is referred to the following detailed description section, which should be read in conjunction with the accompanying drawings, in which:

FIG. 1 depicts an exploded view of the various layers of which the structural element of the present invention is comprised; and

FIG. 2 is a flow chart of the steps of the method of the present invention.

### DETAILED DESCRIPTION OF THE INVENTION

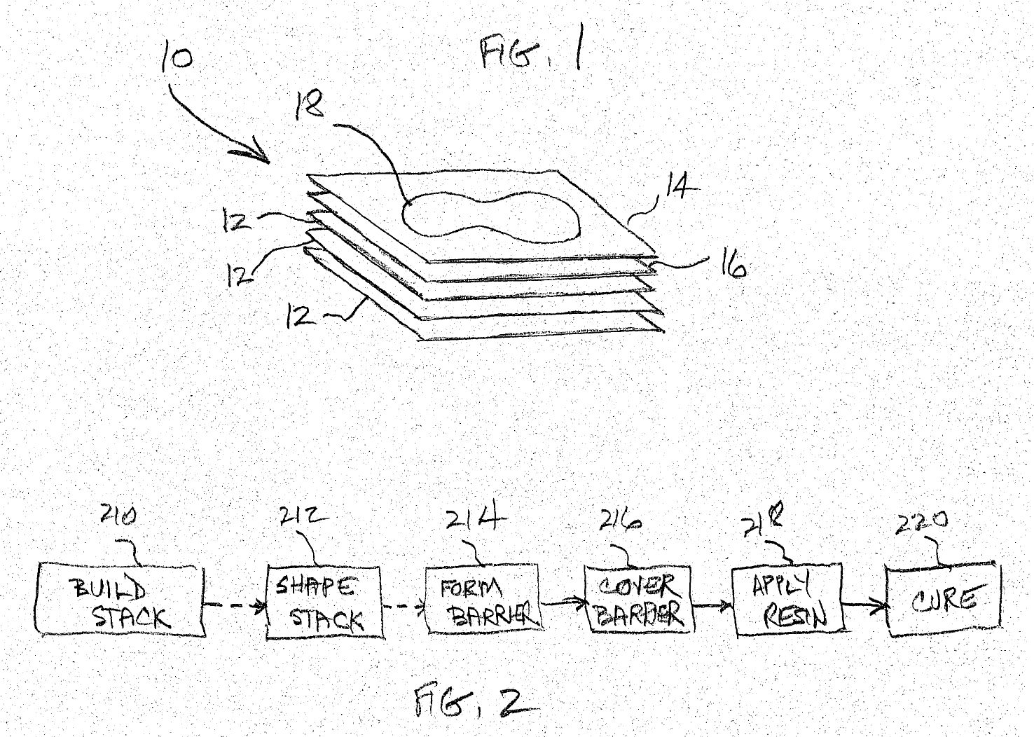

Referring now to FIG. 1 of the drawings, a structural element according to a preferred embodiment of the invention, is shown generally at 10. The element includes a stack of optically dark layers 12 of composite material, and a outer sheet 14 bearing an image 18 that has been applied to the sheet 14 through a sublimation printing process. A barrier layer 16 is disposed between the outer layer 12 of the stack and the image-bearing layer 14. The number of layers 12 in the stack can be as small as one and as large as is necessary to achieve desired mechanical and behavioral properties. It is to be understood (as mentioned above) that one or more of the layers could also be of a non-composite material used for strengthening the structural element. However, such other layers ordinarily would be sandwiched between, or otherwise contained within, the stack of layers of composite material. The image 18 may be on the surface of sheet 14 facing outwardly toward the viewer (as shown in FIG. 1), or facing inwardly toward the stack 12, and disposed between the image-bearing outer sheet 14 and the stack 12 of layers of composite material is a barrier layer 16.

It is to be understood that the term “structural element” as used herein is intended to mean any element having structural capabilities or functions and further having any configuration. The configuration of the structural element shown in FIG. 1 of the drawing is for purposes of illustration only, and is not meant to impose any limitations on the ultimate configuration of the finished product. In fact, the invention contemplates that the layers can have any shape or configuration prior to their being cured.

In one embodiment of the invention, the barrier layer 16 comprises another layer on one surface of which is applied a coating of an optically light pigment. Most preferably, the color of the optically light pigment is white.

In another embodiment of the invention, the side of the barrier sheet 16 facing the stack of layers carries the coating of optically light pigment.

In still another embodiment of the invention, the side of the barrier sheet 16 facing away from the stack of layers carries the coating of optically light pigment.

In yet another embodiment of the invention, the optically light barrier layer 16 may take the form of a film comprising or supporting an optically light pigment, or an optically light pigment suspended in a liquid, where the effect is that the pigment itself is applied to the optically dark composite material layer located immediately behind the layer on which the image has been applied via a sublimation printing process, and which, either in its dry or dried state (prior to application of the resin), forms an opaque layer in combination with, and supported by, the optically dark composite material layer.

The optically light pigment can also be applied to the rear side of the image-bearing layer 14.

Moreover, the optically light pigment can be applied in solution or in the alternative, mixed with an otherwise transparent medium that allows the optically light layer to be applied via a different system of printing, as for example, pigment printing, silk screen printing, laminating, spraying, etc.

FIG. 2 is a flow chart of steps contemplated by the process of the present invention. First, step 210 involves building the stack of layers 12 to the desired thickness. Optional step 212 (shown with a dotted line) involves shaping the stack 12. Step 214 involves forming the barrier layer 16 is formed on or outside of the so-far outer layer 12. As noted above, the barrier layer 16 can be formed by adding another layer of non-composite material impregnated with, or coated by, an optically light pigment, or it can be formed by applying the optically light pigment in solution to the so-far outer layer 12.

Step 216 of the process of the invention involves covering the barrier layer with a layer of pigment.

Step 218 involves the application of resin to the stack of layers. In the alternative, the resin can be applied to each layer of the stack immediately prior to application of each one of the next outer layers being used to build up the stack to the desired thickness.

The barrier layer 16 may be a woven or a nonwoven material.

The material of the optically dark composite material layers may be selected from the group comprising natural or man-made fiberous materials, such as wood, carbon, fiberglass, KEVLAR, or other such materials known in the composite industry.

The resin may be applied to the exterior of the stack of layers to form a transparent protective outer layer.

Alternatively, the resin may be impregnated into the non-composite material barrier layer 16 along with the other layers of which the stack is comprised. Preferably, the resin in the stack of layers bonds the layers together when the resin is cured.

By way of example and not limitation, dipping the various layers into a liquid solution, suspension or emulsion of uncured resin is one way of distributing the resin throughout these layers. Alternatively, the same result may be accomplished by spraying a liquid under pressure into the layers, where the liquid contains uncured resin.

Where appropriate, the resin may be applied to the layers by any conventional method, such as spraying, molding, dipping, brushing, or coating, after the fabric is applied to build up the structural element.

In the method of the present invention, block 220 represents a step of curing the resin on and between all the layers to adhere the layers together. The curing of the resin completes the required steps, and produces a usable composite article having an image field on the outer surface thereof. The resin material will strengthen, reinforce, and protect the structural element of the invention.

Following the curing step, the element 12 may also smoothed on the external surface thereof. This may be done by hand or by machine. Preferably, the smoothing operation is performed by placing the cured element 12 in a grinder, and grinding the external surface until it is smooth.

Although the present invention has been described herein with respect to a preferred embodiment thereof, the foregoing description is intended to be illustrative, and not restrictive. Those skilled in the art will realize that many modifications of the preferred embodiment could be made which would be operable. All such modifications which are within the scope of the claims are intended to be within the scope and spirit of the present invention.

1. A structural element, comprising:
at least one layer of composite material,
curable resin within said layer,
a decorated layer, and
a barrier layer between said decorated layer and said at least one layer of composite material,
said barrier layer comprising an optically light pigment.

2. The structural element of claim 1, wherein said at least one layer comprises an optically dark material.

3. The structural element of claim 1, wherein said optically light pigment is provided on a side of the barrier layer facing the composite material.

4. The structural element of claim 1, wherein said barrier layer comprises a layer of woven polyester material.

5. The structural element of claim 3, wherein said optically light pigment comprises a white pigment.

6. The structural element of claim 3, wherein said barrier layer comprises a layer of non-woven polyester material.

7. The structural element of claim 1, wherein said barrier layer comprises a metallic material.

8. The structural element of claim 1, wherein said at least one layer comprises a stack of layers of composite material and curable resin within which said layers are disposed.

9. The structural element of claim 1, wherein said stack of layers comprises layers having different structural properties, and said barrier layer comprises a layer of woven polyester material.

10. The structural element of claim 3, wherein said optically light pigment comprises a white pigment.

11. The structural element of claim 3, wherein said barrier layer comprises a layer of non-woven polyester material.

12. The structural element of claim 3, wherein said barrier layer comprises a metallic material.

13. A decorative structural element, comprising:
an optically dark laminate material including at least one layer of composite material,
an optically light pigment material supported by said laminate material, and
a decorative image on said laminate material.

14. The decorative structural element of claim 13, wherein said optically dark laminate material includes a reinforcing, material, and said optically light pigment material comprises another layer supported by said laminate material,

15. The decorative element of claim 14, wherein said pigment material comprises a coating.

16. The decorative element of claim 14, wherein said pigment material comprises a film.

17. The decorative element of claim 14, wherein said pigment material comprises polyester material.

18. The decorative element of claim 17, wherein said polyester material comprises a layer of woven fabric.

19. The decorative element of claim 17, wherein said polyester material comprises a layer of non-woven fabric.

20. A process for building a structural element, comprising:
providing at least one layer of composite material,
disposing a barrier layer atop said at least one layer,
providing a decoration atop said barrier layer,
applying a curable resin about said layers, and
curing said resin so that said layers bond together to form an integral structural element.

21. The process of claim 20, wherein said barrier layer comprises an optically light pigment.

22. The process of claim 20, and further including a step of shaping said layers prior to curing said resin, wherein said structural element can be formed with a predetermined shape.

23. The process of claim 20, wherein said at least one layer comprises a stack of layers of composite material, each of said layers: of composite material having its own set of structural properties,
